(19) United States
(12) Patent Application Publication
(10) Pub. No.: US 2006/0098985 A1
(43) Pub. Date: May 11, 2006

(54) Optical signal transmission device and signal transmission system using such a device

(75) Inventors: Kazuhiro Sakai, Ashigarakami-gun (JP); Tsutomu Hamada, Ashigarakami-gun (JP); Masaru Kijima, Ashigarakami-gun (JP); Hisayoshi Mori, Ashigarakami-gun (JP); Yoshihide Sato, Ashigarakami-gun (JP); Osamu Ueno, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/129,356

(22) Filed: May 16, 2005

(30) Foreign Application Priority Data
Nov. 10, 2004 (JP) 2004-326350

(51) Int. Cl. H04B 10/00

(52) U.S. Cl. 398/138

(57) ABSTRACT

An optical signal transmission device including an optical signal receiving section, an optical signal transmitting section, a support member, and a digital signal control section. The optical signal receiving section receives an optical signal by a light-receiving element mounted on a board, converts the optical signal to a digital electric signal and outputs the digital electric signal. The digital signal control section processes the digital electric signal. The optical signal transmitting section converts a digital electric signal to an optical signal by a light-emitting element and outputs the optical signal. The optical signal receiving section and the optical signal transmitting section are provided on different surfaces of a support member.

### CROSS-REFERENCE TO RELATED APPLICATION

This application claims priority under 35 U.S.C. 119 from Japanese Patent Application No. 2004-326350, the disclosure of which is incorporated by reference herein.

### BACKGROUND OF THE INVENTION

1. Field of the Invention

The present invention relates to an optical signal transmission device and a signal transmission system using such a device.

2. Description of the Related Art

Along with increasing resolution of liquid crystal displays and plasma displays, there is a requirement to transmit a high volume video signal still as a digital signal. For example, according to the Digital Visual Interface (DVI) standard established by an industry organization Digital Display Working Group (DDWG), which is a differential signal standard called Transition Minimized Differential Signaling (TMDS), video information is transmitted by a high-speed signal of 1.65 Gbps per channel, while display information or the like is transmitted by a low-speed signal in the form of a DDC signal from a display to a host.

Transmission medium for this purpose generally uses a shielded metal cable which is commonly used as a display cable, but due to high-speed of the signal, there is a problem that the cable cannot be lengthened longer than 10 m.

In order to address the above problem, there has been proposed a system wherein the digital signal is converted to an optical signal which in turn is transmitted a long distance (for example, refer to JP-A No. 2004-241915).

However, in the optical signal transmitting/receiving module disclosed in JP-A No. 2004-241915 mentioned above, an optical signal transmitting section and an optical signal receiving section are disposed on the same board in adjacent relationship to each other, and thus are easily susceptible to the influence of cross-talk therebetween, which tends to result in disturbance of an output image.

### SUMMARY OF THE INVENTION

In view of the foregoing, the present invention provides an optical signal transmission device arranged such that cross-talk is less likely to occur between an optical signal transmitting section and an optical signal receiving section in an optical signal transmitting/receiving module, and an optical signal transmission system using such a device.

A first aspect of the present invention provides an optical signal transmission device including: an optical signal receiving section that receives an optical signal by a light-receiving element mounted on a board, converts the optical signal to a digital electric signal and outputs the digital electric signal; an optical signal transmitting section that converts a digital electric signal to an optical signal by a light-emitting element and outputs the optical signal; a support member that holds the optical signal receiving section and the optical signal transmitting section; and a digital signal control section that processes the digital electric signal; wherein the support member has at least two surfaces; and the optical signal receiving section and the optical signal transmitting section are provided on different surfaces of the support member.

A second aspect of the present invention provides a signal transmission system including: a first signal transmitting/receiving module; a second signal transmitting/receiving module; and at least two signal transmission mediums connecting the first signal transmitting/receiving module and the second signal transmitting/receiving module; wherein the first signal transmitting/receiving module converts at least a portion of an externally inputted first electric signal to an optical signal and transmits the first optical signal, while receiving a second optical signal transmitted from the second signal transmitting/receiving module and converting the second optical signal to a second electric signal; wherein the second signal transmitting/receiving module converts at least a portion of the first optical signal transmitted by the first signal transmitting/receiving module to a third electric signal and outputs the third electric signal, while converting a portion of an externally inputted forth electric signal to the second optical signal and transmitting the second optical signal to the first signal transmitting/receiving module; and wherein at least one of the first and second signal transmitting/receiving modules includes: an optical signal receiving section that receives an optical signal by a light-receiving element mounted on a board, converts the optical signal to a digital electric signal and outputs the digital electric signal; an optical signal transmitting section that converts a digital electric signal to an optical signal by a light-emitting element and outputs the optical signal; a support member that holds the optical signal receiving section and the optical signal transmitting section; and a digital signal control section that processes the digital electric signal; wherein the support member has at least two surfaces; and the optical signal receiving section and the optical signal transmitting section are provided on different surfaces of the support member.

Other aspects, features and advantages of the present invention will become apparent from the following description taken in conjunction with the accompanying drawings.

### BRIEF DESCRIPTION OF THE DRAWINGS

Preferred embodiments of the present invention will be described in detail based on the following figures, wherein:

FIG. 1 is a block diagram illustrating a schematic configuration of an optical signal transmission system including an optical signal transmission device according to an embodiment of the present invention;

FIG. 2 is a perspective view showing an optical signal transmission device according to an embodiment of the present invention;

FIG. 3 is an exploded perspective view illustrating a receptacle for an optical signal transmission device according to an embodiment of the present invention, and an optical signal transmitting section and an optical signal receiving section which are secured to the receptacle;

FIG. 4A is a top sectional view of an optical signal transmission device according to an embodiment of the present invention;

FIG. 4B is a side sectional view of the optical signal transmission device according to an embodiment of the present invention; and

FIG. 5 is a development view of a flex-rigid board for an optical signal transmission device according to an embodiment of the present invention

### DETAILED DESCRIPTION OF THE INVENTION

Description will now be made of an optical signal transmission device 12 according to an embodiment of the present invention

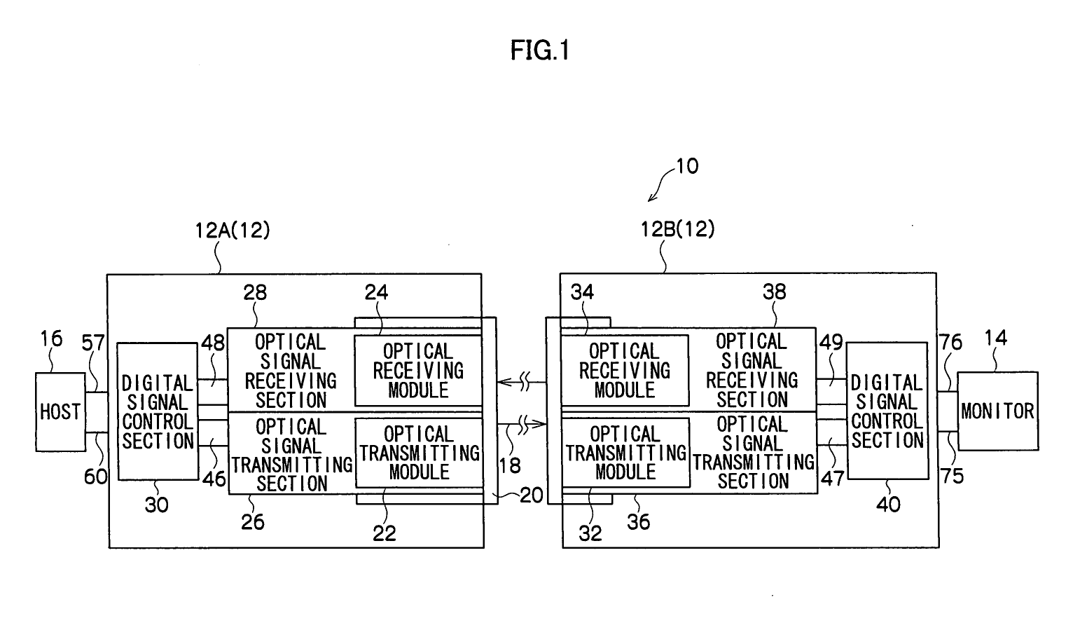

First, a video signal transmission system 10 including the optical signal transmission device 12 according to the present invention will be briefly described with reference to FIG. 1.

The video signal transmission system 10 is a system for displaying a video signal from a host 16 on a monitor 14. A video signal outputted from the host 16 is converted to an optical signal at an optical signal transmission device 12A, and then transmitted through an optical cable 18 to an optical signal transmission device 12B connected to the monitor 14. The optical signal transmission device 12B converts an optical signal transmitted from the optical signal transmission device 12A into a digital signal and causes the digital signal to be displayed on the monitor 14

A signal such as to the DVI standard, established as a standard for video signal by the DDWG, an industry organization, is applicable as a digital signal transmitted by the optical signal transmission device 12. Further, besides DVI signals, non-DVI signals for exchanging audio information or remote control information are also applicable.

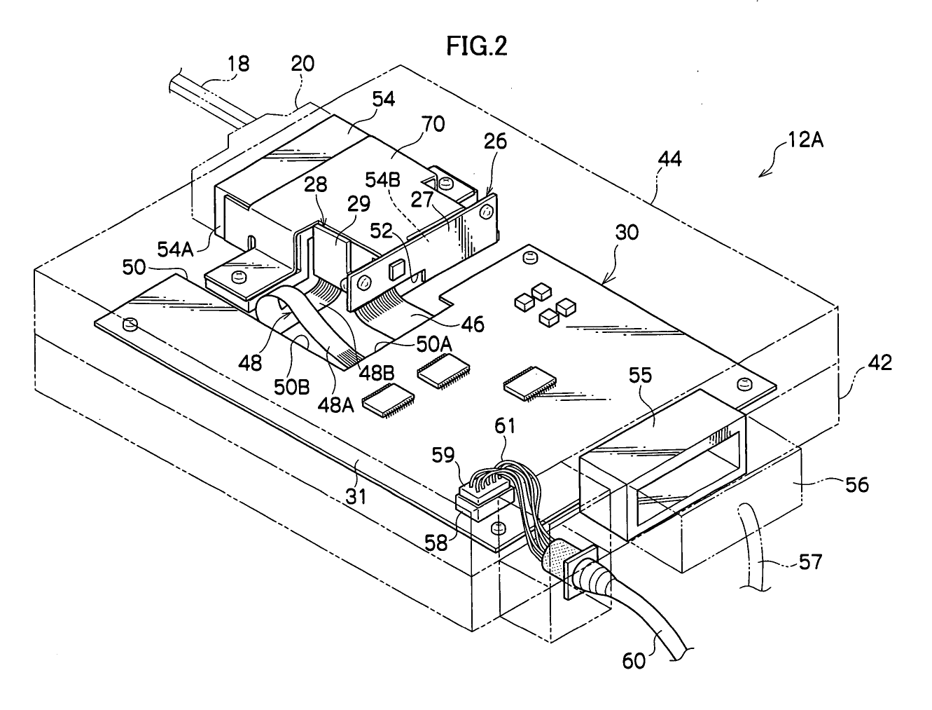

As shown in FIGS. 1 and 2, the optical signal transmission device 12A is connected to the host 16, and the optical signal transmission device 12B is connected to the monitor 14.

The optical signal transmission devices 12A and 12B have a substantially identical structure, and therefore the optical signal transmission device 12A will be described by way of example.

The optical signal transmission device 12A is comprised of an optical signal transmitting section 26, an optical signal receiving section 28, and a digital signal control section 30. The optical signal transmitting section 26 is comprised of an optical transmitting module 22, and a rigid board 27 on which the optical transmitting module 22 is mounted. Further, the optical signal receiving section 28 is comprised of an optical receiving module 24, and rigid board 29 on which the optical receiving section 24 is mounted.

Further, as shown in FIG. 2, the optical signal transmission device 12A includes a box-shaped housing 42, and a lid 44 covering an opening of the housing 42. On the bottom of the housing 42 is provided a rigid board 31 which constitutes the digital signal control section 30. The rigid board 31 has a notched portion 50 formed in one corner thereof and thus is configured into an approximately L-shaped form. At a position corresponding to the notched portion 50, there is provided a receptacle 54 as a support member.

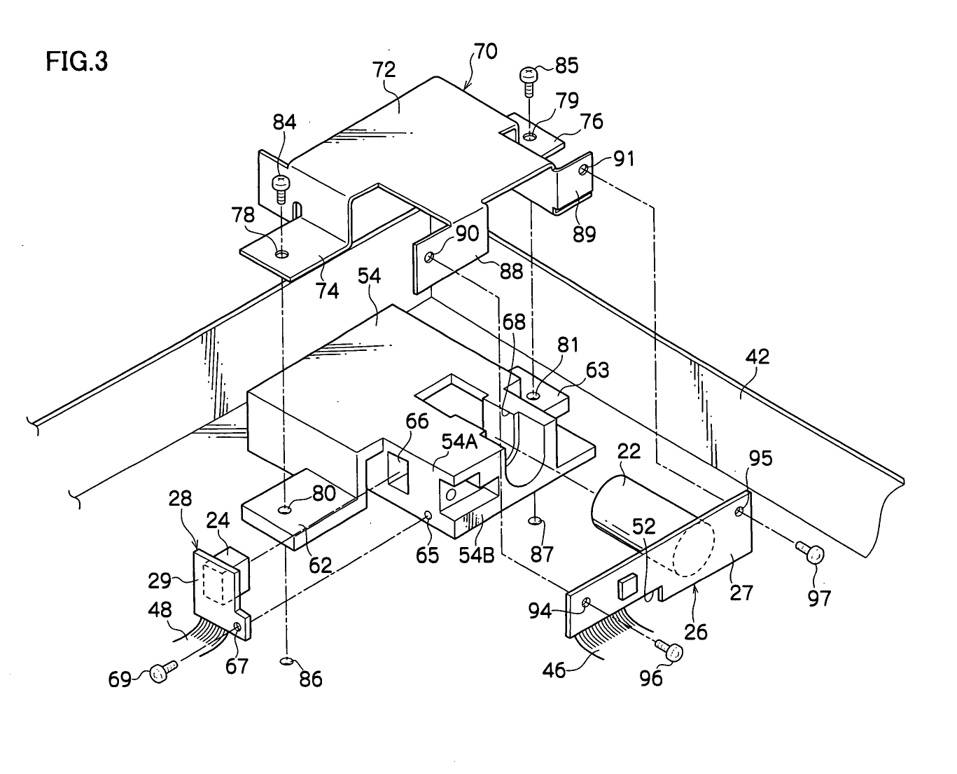

As shown in FIG. 3, the receptacle 54 has a substantially rectangular box-like shape having a side surface 54A disposed in opposing relationship to a second edge 50B (see FIG. 2) of the notched portion 50, and thin plate portions 62 and 63 extending from side surfaces parallel to the side surface 54A.

The receptacle 54 is adapted to be covered by a shield member 70 from above. The shield member 70 has an approximately rectangular shaped plate member 72 which is provided with arm members 74 and 76 extending from opposite end portions thereof and each being approximately L-shaped as viewed from one direction. The arm members 74 and 76 are provided at positions where they respectively overlap the plate portions 62 and 63 provided on the receptacle 54 when the receptacle 54 is covered by the shield member 70.

The arm members 74 and 76 are formed with through-apertures 78 and 79 respectively. The receptacle 54 is covered by plate member 72 and arm members 74, 76, then screws 84 and 85 are inserted through the through-apertures 78 and 79, and through apertures 80 and 81 formed through the plate portions 62 and 63 of the receptacle 54, and then the screws 84 and 85 are screwed into threaded apertures 86 and 87 respectively. In this manner, the receptacle 54 covered by the shield member 70 is fixed to the bottom of the housing 42.

Further, plate pieces 88 and 89 are provided on the other end portion of the plate member 72 in such a manner as to extend along a side surface 54B (see FIG. 2) of the receptacle 54 which is disposed in opposing relationship to a first edge 50A of the notched portion 50. The plate pieces 88 and 89 are respectively formed with threaded apertures 90 and 91. Screws 96 and 97 are inserted through apertures 94 and 95 formed through the rigid board 27 constituting the optical signal transmitting section 26, and screwed into the threaded apertures 90 and 91, thereby securing the rigid board 27 to the shield member 70. In this manner, the rigid board 27 is supportingly secured to the side surface 54B of the receptacle 54.

A recessed portion 68, which is approximately U-shaped in cross-section, is formed in the side surface 54B of the receptacle 54. With the rigid board 27 supportingly secured to the side surface 54B of the receptacle 54, the cylindrical optical transmitting module 22 mounted on the rigid board 27 is inserted in the recessed portion 68 and positioned therein.

Further, a threaded aperture 65 is formed in the side surface 54A of the receptacle 54. By inserting a screw 69 through an aperture 67 formed through the rigid board 29 constituting the optical signal receiving section 28 and then screwing the screw 69 into the threaded aperture 65, the rigid board 29 is supportingly secured to the side surface 54A of the receptacle 54.

A substantially rectangular opening portion 66 is formed in the side surface 54A. With the rigid board 29 supportingly secured to the side surface 54A, the square column shaped optical receiving section 24 mounted on the rigid board 29 is inserted in the opening portion 66 and positioned therein.

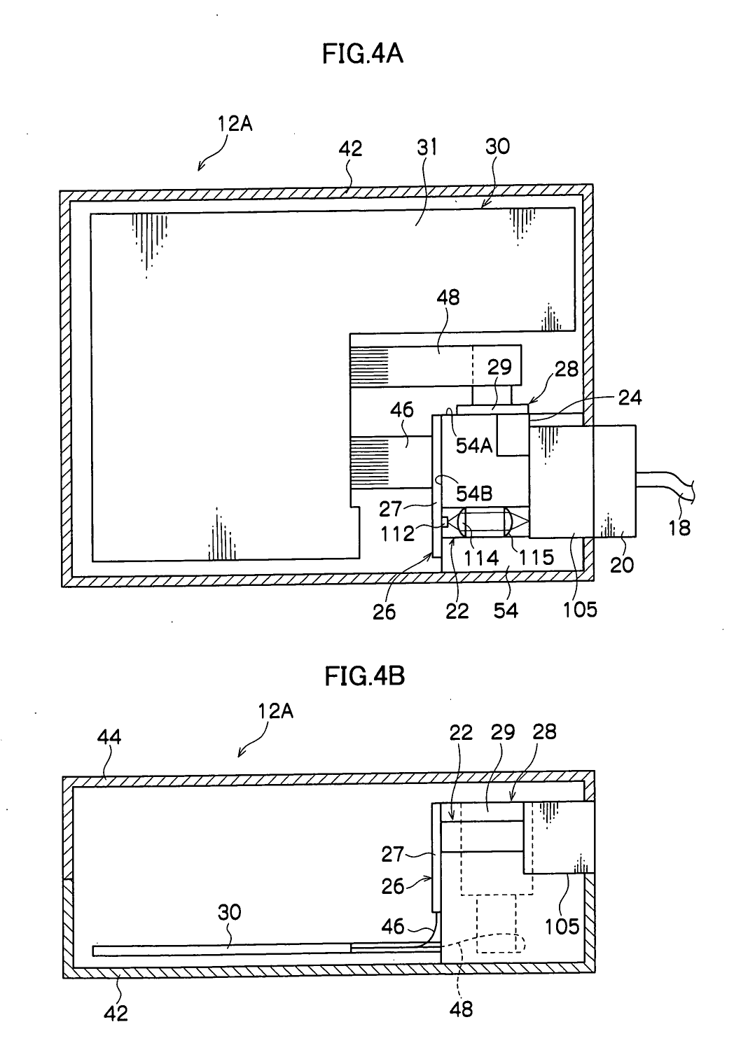

As shown in FIG. 4A, a connector 105 is mounted to a side wall of the housing 42 which intersects with an extension line of the optical transmitting module 22. The connector 105 is adapted to be engaged with a connector 20 to which the optical fiber is connected, so that an optical signal is outputted to the optical receiving module 24 and an optical signal is inputted thereto from the optical transmitting module 22, through the optical cable 18.

More specifically, the optical transmitting module 22 includes a light emitting element 112 and lenses 114 and 115. An optical signal emitted from the light emitting element is transformed into parallel light rays by the lens 114, and then focussed by the lens 115 and guided to the connector 105 to be outputted to optical fibers of the optical cable 18.

Further, although not shown, the optical receiving module 24 includes a light receiving element, a receiving amplifier, and lenses so that an optical signal inputted to the optical receiving module 24 from the optical fibers of the optical cable 18 through the connector 105 is focussed by the lens and inputted to the light receiving element.

Furthermore, as shown in FIG. 2, a female connector 58 is mounted on the rigid board 31 on the side opposite to the side where the receptacle 54 is provided. The female connector 58 is adapted to be engaged with a male connector 59 connected to a harness 61 of a shield cable 60. Thus, a video signal or the like is transmitted from the host 16 (see FIG. 1) to the digital signal control section 30 (rigid board 31) through the shield cable 60.

Further, a female connector 55 is provided on the rigid board 31. The female connector 55 is adapted to be engaged with a male connector 56 connected to one end of a shield cable 57 so that a control signal is transmitted to the host 16 through the shield cable 57.

Meanwhile, the optical signal transmission device 12B (see FIG. 1), which is connected to the monitor 14, is configured, like the optical signal transmission device 12A, such that a video signal is transmitted to the monitor 14 through a shield cable 75 and a control signal is transmitted from the monitor 14 to the digital signal control section 40 through a shield cable 76.

On the other hand, the rigid board 27 and the rigid board 31 are connected to each other by a flexible portion 46, and the rigid board 29 and the rigid board 31 are connected to each other by a flexible portion 48.

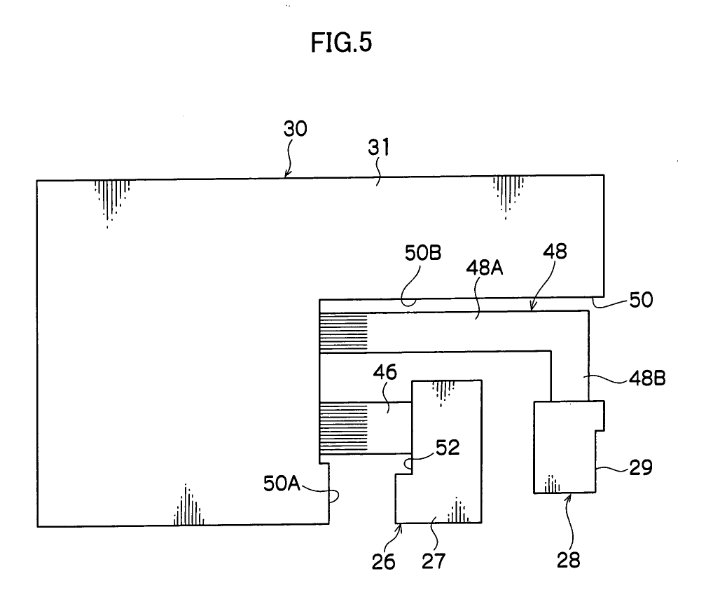

FIG. 5 illustrates a state before the rigid boards 27 and 29 are supportingly secured to the receptacle 54, i.e., a state that the flexible portion 46 connecting the rigid boards 27 and 31 and the flexible portion 48 connecting the rigid boards 29 and 31 are unfolded.

On the side of the first edge 50A of the notched portion 50 of the rigid board 31 constituting the digital signal control section 30, there is disposed the rigid board 27 constituting the optical signal transmitting section 26. The rigid board 27 is configured in an approximate L-shape by being formed with a recessed portion 52 at a position opposing to the first edge 50A. The flexible portion 46 connected at one end to the first edge 50A of the notched portion 50 is connected at the other end to the recessed portion 52. Thus, the rigid board 27 is electrically connected to the rigid board 31 by the flexible portion 46.

Further, the rigid board 29 constituting the optical signal receiving section 28 is disposed at the recessed portion 50 in a manner to be parallel with the rigid board 27. The rigid board 29 is electrically connected to the rigid board 31 by the flexible portion 48.

The flexible portion 48 is configured in an L-shaped form consisting of a long portion 48A connected at one end to the first edge 50A of the notched portion 50 and extending in parallel with the flexible portion 46 over a length beyond the rigid board 27, and a short portion 48B extending in perpendicular relationship to the long portion 48A and in an opposite direction to the second edge 50B of the notched portion 50. The short portion 48B is connected to an edge of the rigid board 29 which is disposed in opposing relationship to the second edge 50B of the notched portion 50.

With the flexible portions 46 and 48 unfolded as shown in FIG. 5, let it be assumed that for each of the rigid boards 27 and 29, the drawing surface side is a front surface and the opposite side is a rear surface. Meanwhile, as shown in FIG. 2, the rigid board 27 is supportingly secured, with the flexible portion 46 folded through approximately 90 degrees such that the rear surface of the rigid board 27 is disposed in opposing relationship to the side surface 54B of the receptacle 54.

Further, the rigid board 29 is supportingly secured, with the long portion 48A of the flexible portion 48 folded through approximately 180 degrees and with the short portion 48B of the flexible portion 48 folded through approximately 90 degrees such that the front surface of the rigid board 29 is disposed in opposing relationship to the side surface 54B of the receptacle 54.

On the other hand, the host 16 outputs a video signal, an audio signal, and a control signal, and the monitor 14 outputs a control signal. That is, the quantity of data outputted from the host 16 is greater than that outputted from the monitor 14. Thus, it is required that data outputted from the host 16 be transmitted as a high-speed signal, whereas data outputted from the monitor 14 may be transmitted as a slow-speed signal.

Accordingly, it is arranged such that a signal directed from the host 16 to the monitor 14 is transmitted through the shorter flexible portions 46 and 47 while a signal directed from the monitor 14 to the host 16 is transmitted through the longer flexible portions 48 and 49. This makes it possible to suppress degradation of a high-speed signal that is directed from the host 16 to the monitor 14.

As shown in FIG. 1, a signal such as a video signal is outputted from the host 16 to the optical signal transmission device 12A connected to the host 16. This signal is then transmitted from the digital signal control section 30 to the rigid board 27 (see FIG. 4) of the optical signal transmitting section 26 via the flexible portion 46. Here, the signal is converted to an optical signal by the light-emitting element 112 of the optical transmitting module 22, and transmitted through the optical cable 18 to the light receiving element of the optical receiving module 32 of the optical signal transmission device 12B connected to the monitor 14. Then, the optical signal is converted to a digital electric signal by the light-receiving element, and transmitted from the rigid board of the optical signal receiving section 36 to the digital control signal section 40 through the flexible portion 47 so as to be outputted as an image on the monitor 14.

Further, a control signal derived from the monitor 14 is outputted to the optical signal transmission device 12B connected to the monitor 14. This signal is transmitted from the digital control signal section 40 to the optical signal transmitting section 38 via the flexible portion 49. Here, the signal is converted to an optical signal by the light-receiving element of the optical receiving module 34, and transmitted through the optical cable 18 to the light-receiving element 110 of the optical receiving module 24 of the optical signal transmission device 12A connected to the host 16. Then, the optical signal is converted to a digital electric signal by the light-receiving element 110, and transmitted from the rigid board 29 of the optical signal receiving section 28 to the digital control signal section 30 via the flexible portion 48 so as to be inputted to the host 16.

At this point, as shown in FIG. 2, the rigid board 27 constituting the optical signal transmitting section 26, and the rigid board 29 constituting the optical signal receiving section 28 are supportingly secured to different side surfaces of the receptacle 54. If the optical signal receiving section 28 and the optical signal transmitting section 26 are disposed side by side on a common plane, then cross-talk tends to occur therebetween. However, by forming the optical signal receiving section 28 and optical signal transmitting section 26 by the separate rigid boards 27 and 29 respectively and by disposing the optical signal receiving section 28 and optical signal transmitting section 26 out of adjacency with each other, it is possible to suppress the occurrence of cross talk, thereby producing a favorable image.

Further, by virtue of the fact that the optical signal receiving section 28 and optical signal transmitting section 26 are not disposed side by side on the same side surface of the receptacle 54, the width size of the side surface of the receptacle 54 can be prevented from becoming unnecessarily large, and thus the size of the optical signal transmission device 12 can be prevented from becoming large.

Still further, because of the digital signal control section 30 and optical signal transmitting section 26 being connected by the flexible portion 46, and because of the digital signal control section 30 and optical signal receiving section 28 being connected by the flexible portion 48, the degree of freedom for disposing the optical signal receiving section 28 and optical signal transmitting section 26 is enhanced; thus, the optical signal receiving section 28 and optical signal transmitting section 26 can be supportingly secured to different side surfaces of the receptacle 54 with ease.

Furthermore, since accuracy is not required of the positional relationship between the digital signal control section 30 and the optical signal transmitting section 26 and optical signal receiving section 28 or the positional relationship between the digital signal control section 30 and the receptacle 54, the manufacturing process is shortened, which leads to cost reduction.

Further, in a state that the flexible portions 46 and 48 are unfolded as shown in FIG. 5, the flexible portions 46 and 48 are connected at one end to one edge of the notched portion 50 of the digital signal control section 30, and the flexible portion 48 is made longer than the flexible portion 46 and bent through 90 degrees into an L-shape. In this manner, the optical signal transmitting section 26 and optical signal receiving section 28 can be located at the notched portion 50 of the digital signal control section 30 without interference with each other. In addition, the rigid board 27 of the optical signal transmitting section 26, the rigid board 29 of the optical signal receiving section 28, and the rigid board 31 of the digital signal control section 30 can be made from a single rigid board. This increases the stability of a digital electric signal exchanged between the optical signal receiving section 28 and the digital signal control section 30 and that of a digital electric signal exchanged between the digital signal control section 30 and the optical signal transmitting section 26, thereby preventing operational errors.

Further, the optical signal receiving section 28 can be mounted onto a side surface of the receptacle 54, with the flexible portion 48 folded back through approximately 180 degrees. That is, since the flexible portion 48 is not twisted, unnecessary stress is not applied to the flexible portion, and in addition the flexible portion 48 is pressed against the bottom surface of the housing 42 due to its own resiliency; thus, unwanted radiation can be reduced.

In the present embodiment, it has been arranged such that signal transmission is performed between the digital signal control section 30 and the optical signal transmitting module 22 and optical signal receiving module 24 via the rigid boards 27 and 29. With such an arrangement, there is no need to use a connector, and thus unwanted radiation which tends to be produced by a connector can be prevented. Further, since there is no need to use a connector, the number of parts can be reduced accordingly, which also leads to cost reduction.

While the present invention has been illustrated and described with respect to specific embodiments thereof, it is to be understood that the present invention is by no means limited thereto and encompasses all changes and modifications which will become possible without departing from the spirit and scope of the present invention.

What is claimed is:

1. An optical signal transmission device comprising:
an optical signal receiving section that receives an optical signal by a light-receiving element mounted on a board, converts the optical signal to a digital electric signal and outputs the digital electric signal;
an optical signal transmitting section that converts a digital electric signal to an optical signal by a light-emitting element and outputs the optical signal;
a support member that holds the optical signal receiving section and the optical signal transmitting section; and
a digital signal control section that processes the digital electric signal;
wherein the support member has at least two surfaces; and the optical signal receiving section and the optical signal transmitting section are provided on different surfaces of the support member.

2. The optical signal transmission device according to claim 1, wherein the support member is generally box-shaped; and the optical signal receiving section and the optical signal transmitting section are provided on different surfaces of the support member.

3. The optical signal transmission device according to claim 1, wherein the digital signal control section is connected to both the optical signal receiving section and the optical signal transmitting section, processes a digital electric signal outputted from the optical signal receiving section, and generates a digital electric signal which is outputted to the optical signal transmitting section, the optical signal transmission device further comprising:
a first flexible wiring board that connects the optical signal receiving section and the digital signal control section; and
a second flexible wiring board that connects the optical signal transmitting section and the digital signal control section.

4. The optical signal transmission device according to claim 3, wherein the first flexible wiring board and the second flexible wiring board are different in length from each other.

5. The optical signal transmission device according to claim 4, wherein the first flexible wiring board and the second flexible wiring board are connected to a single edge of a circuit board constituting the digital signal control section; and a longer one of the first flexible wiring board and the second flexible wiring board is wired in an L-shaped configuration.

6. The optical signal transmission device according to claim 4, wherein a signal that is transmitted through a shorter one of the first flexible wiring board and the second flexible wiring board is transmitted at a higher speed than a signal that is transmitted through a longer one of the first flexible wiring board and the second flexible wiring board.

7. A signal transmission system comprising:
a first signal transmitting/receiving module;
a second signal transmitting/receiving module; and
at least two signal transmission mediums connecting the first signal transmitting/receiving module and the second signal transmitting/receiving module;
wherein the first signal transmitting/receiving module converts at least a portion of an externally inputted first electric signal to a first optical signal and transmits the first optical signal, while receiving a second optical signal transmitted from the second signal transmitting/receiving module and converting the second optical signal to a second electric signal;
wherein the second signal transmitting/receiving module converts at least a portion of the first optical signal transmitted by the first signal transmitting/receiving module to a third electric signal and outputs the third electric signal, while converting a portion of an externally input fourth electric signal to the second optical signal and transmitting the second optical signal to the first signal transmitting/receiving module; and
wherein at least one of the first and second signal transmitting/receiving modules comprises:
an optical signal receiving section that receives an optical signal by a light-receiving element mounted on a board, converts the optical signal to a digital electric signal and outputs the digital electric signal;
an optical signal transmitting section that converts a digital electric signal to an optical signal by a light-emitting element and outputs the optical signal;
a support member that holds the optical signal receiving section and the optical signal transmitting section; and
a digital signal control section that processes the digital electric signal;
wherein the support member has at least two surfaces; and the optical signal receiving section and the optical signal transmitting section are provided on different surfaces of the support member.

8. The signal transmission system according to claim 7, wherein the support member is generally box-shaped; and the optical signal receiving section and the optical signal transmitting section are provided on different surfaces of the support member.

9. The signal transmission system according to claim 7, wherein the digital signal control section is connected to both the optical signal receiving section and the optical signal transmitting section, processes a digital electric signal outputted from the optical signal receiving section, and generates a digital electric signal which is outputted to the optical signal transmitting section, the optical signal transmission device further comprising:
a first flexible wiring board that connects the optical signal receiving section and the digital signal control section; and
a second flexible wiring board that connects the optical signal transmitting section and the digital signal control section.

10. The signal transmission system according to claim 9, wherein the first flexible wiring board and the second flexible wiring board are different in length from each other.

11. The signal transmission system according to claim 10, wherein the first flexible wiring board and the second flexible wiring board are connected to a single edge of a circuit board constituting the digital signal control section; and a longer one of the first wiring board and the second wiring board is wired in an L-shaped configuration.

12. The signal transmission system according to claim 10, wherein a signal that is transmitted through a shorter one of the first flexible wiring board and the second flexible wiring board is transmitted at a higher speed than a signal that is transmitted through a longer one of the first flexible wiring board and the second flexible wiring board.
